(19) United States
(12) Patent Application Publication
(10) Pub. No.: US 2006/0188678 A1
(43) Pub. Date: Aug. 24, 2006

(54) Multi-layer polyethylene films

(76) Inventors: Stefan Bertil Ohlsson, Wespelaar (BE); Bart Lauwers, Schriek (BE)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/062,152

(22) Filed: Feb. 21, 2005

(51) Int. Cl. B32B 27/08; B32B 27/32

(52) U.S. Cl. 428/35.7; 428/516; 428/218; 428/213

(57) ABSTRACT

An improved multi-layer film and packaging, including heavy duty sacks made therefrom having improved properties that permit processing on high speed bagging/Form Fill-Seal equipment are disclosed. The multi-layer films of the invention include a mLLDPE-containing skin layer and a core layer that includes both HDPE and mLLDPE.

### FIELD OF THE INVENTION

The invention relates to films prepared from polyethylene resins. More specifically, the invention relates to multi-layer films made from particular polyethylene compositions for use in heavy duty sacks and other packaging applications.

### BACKGROUND OF THE INVENTION

Form Fill and Seal (FFS) packaging systems are cost effective for bagging bulk products such as chemicals, polymers, fertilizers, and animal food. To improve the economics and competitiveness of the FFS systems, high speed machines have been developed capable of filling up to 2500 bags per hour.

The higher the speed of the FFS system, the more critical the characteristics of the film become. U.S. Pat. No. 5,756,193 discloses polyethylene resin blends for heavy duty packaging bags comprising a majority component of linear low density polyethylene (LLDPE), a linear medium density polyethylene (MDPE) or linear high density polyethylene (HDPE), and low density polyethylene (LDPE). This three-component blend, when used in a film and formed into a bag, was reported to have better bag break properties (fewer breaks when dropped from a given height) that the comparative bags. Good machineability (i.e., bag filling and palletization operation) requires the film to have a certain minimum stiffness. The minimum stiffness in turn requires the overall density (crystallinity) be increased in order to downgauge the film thickness. However, the increased density often causes poor impact properties, such as edge fold impact strength and seal rupture when a bag is dropped. The weakest area of the film tends to be adjacent to the seal area where the film is thinner as a result of the stresses the film is exposed to during the sealing operation. This thinning phenomenon is typical for the linear types of polyethylene (PE) that are required for short sealing time and high hot tack seal strength.

Film thicknesses in heavy duty sack applications have been reduced from 250 μm monolayer films to 125 μm multilayer films using coextrusion techniques and composition optimization. For example, U.S. Pat. No. 5,491,019 discloses a 75 μm gauge monolayer film that is stated to have optical and seal properties inferior to those of the multilayer films having a thickness in the range of 37.5 μm to 45 μm.

Stiffness, clarity and sealability of multi-layer films have been improved somewhat by utilizing a high density polyethylene as a stiffening layer with a single-site catalyzed polyethylene sealant layer as disclosed in, inter alia, EP743902B1. Present high speed bagging equipment and the rigors to which heavy duty sacks are subjected, however, require better multi-layer films to minimize bag failure.

Thus, there exists a need for improved multi-layer films and heavy duty packaging made therefrom that have improved properties to permit processing on high speed bagging equipment to form heavy duty sacks. Particularly, multi-layer films and heavy duty sacks having greater machine direction tear strength, greater creep resistance (at the same gauge) while still having excellent dart drop, sealability, seal strength and clarity characteristics are desirable; the combination of these characteristics gives better bag drop performance even when the packaging material is made/filled on high speed bagging equipment.

### SUMMARY OF THE INVENTION

The present invention provides a multilayer film structure, a method of making the film, and heavy duty sacks made therefrom, suitable for FFS packaging of various materials, wherein downgauging is possible while still meeting stiffness, toughness, sealing and optical criteria.

One embodiment according to the invention provides a multilayer film having: a single-site catalyzed resin as a first layer; a second layer comprising a medium-high molecular weight HDPE as a majority component; and a single-site catalyzed resin as a third layer. While not wishing to be held to any single theory, it is thought that this construction provides good sealing properties at relatively low temperatures with the first and third or skin layers being single-site catalyzed resins while providing the necessary stiffness component by using HDPE as the majority component in the core or second layer. The use of the medium-high molecular weight HDPE also allows the overall structure to maintain the seal strength and impact resistance, while also minimizing creep. Processability, also needed for downgauging, is assisted by the addition of a minority amount (5%±5% by weight) of LDPE being optionally blended into any or all of the three layers. Furthermore, compatibility and dart impact characteristics may be assisted by the optional blending of a minor amount of single-site catalyzed resin into the second or core layer.

With regard to the second layer, an embodiment according to the invention comprises a majority of HDPE; preferably from about 60 to 90% by weight (“wt %”) of an HDPE having a density ranging from about 0.940 g/cm³ to about 0.965 g/cm³ and a melt index ranging from at least about 0.1 to about 1.0 g/10 min. The remainder of the second layer preferably comprises from about 40 to 10 wt % of an mLLDPE having a density ranging from about 0.910 g/cm³ to about 0.930 g/cm³ and a melt index ranging from at least about 0.2 to about 3.5 g/10 min. It should be noted that the weight percentages throughout this disclosure are based on the total of the disclosed compositions; additional compositions may be added to any given blend or layer, and that may cause the total to be greater than 100 wt %. The second layer may optionally also comprise an LDPE in amounts ranging up to about 10 wt %.

With regard to the first layer, a multi-layer film of the present invention comprises at least 80 wt % of a first mLLDPE having a density ranging from about 0.910 to about 0.930 g/cm³. The remainder of this first layer may be less than about 20 wt % of a first LDPE wherein the wt % is based on the total weight of the first layer. The first layer may also be referred to as a “skin layer”.

The third layer (that may also be referred to as a skin layer, particularly when it is substantially the same as the first layer), which may be the same or different from the first layer, comprises at least 80 wt % of a third mLLDPE having a density ranging from about 0.910 to about 0.930 g/cm³. The remainder of this third layer may be less than about 20 wt % of a third LDPE wherein the wt % is based on the total weight of the third mLLDPE and the third LDPE of the third layer.

The multi-layer film of the present invention is made by coextruding the resins of the first, second and third layers, as described above, into a multi-layer film in which the second layer is located between the first and third layers, using standard film-forming equipment. The film is preferably blown into a film using film-forming equipment having at least two extruders (for example, in the case of an A/B/A structure) leading to a circular die through which the resin is extruded, forming a bubble that is a circular film. The bubble may be split into two flat films, cut, longitudinally sealed into smaller diameter tubes, gusseted and wound onto a roll. The rolled smaller tube may then be used in the FFS bagging operation. A process of sealing such a multi-layer film by subjecting the multi-layer film to sufficient heat and pressure to form a seal; and the use of such a multi-layer film as a package, preferably in heavy duty sacks; are also given.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view of a multi-layered film of the present invention.

FIG. 2 is a cross-sectional view of a second embodiment of a multi-layered film of the present invention.

FIGS. 3a, 3b, 3c and 3d are cross-sectional views of a multi-layered film of the present invention.

FIG. 4 is a star chart of the data in Table 2.

FIG. 5 is a star chart exemplifying an embodiment of the present invention and comparing it to a high performance bag and the estimated minimum standard for Form-Fill-Seal operations.

### DETAILED DESCRIPTION

Applicants have developed improved multi-layer films and packaging, including heavy duty sacks, made therefrom that have improved properties that permit processing on high speed bagging/FFS equipment. These multi-layered films and packaging materials may also (or alternatively) have improved properties, allow for down-gauging, and/or have faster running rates on the film manufacturing equipment. Description of Polyethylene Resins Useful in the Inventive Multi-Layer Film, Packaging Material and Heavy Duty Sacks.

For the purposes of this disclosure, the following definitions will be generally applicable: Low density polyethylene (“LDPE”) can be prepared at high pressure using free radical initiators, and typically has a density in the range of 0.915-0.940 g/cm³. LDPE is also known as “branched” or “heterogeneously branched” polyethylene because of the relatively large number of long chain branches extending from the main polymer backbone. LDPE has been commercially manufactured since the 1930's and is well known in the art.

Polyethylene in an overlapping density range, i.e., 0.890 to 0.900 g/cm³, more typically 0.915 to 0.930 g/cm³, which is linear and does not contain long chain branching is also known. This “linear low density polyethylene” (“LLDPE”) can be produced with conventional Ziegler-Natta catalysts, vanadium catalysts or with metallocene catalysts in gas phase reactors and/or with metallocene catalysts in slurry reactors and/or with any of the disclosed catalysts in solution reactors. The LLDPE reaction systems are relatively low pressure reactor systems. LLDPE has also been commercially manufactured for a long time (since the 1950's for the slurry reactors, since the 1980's for the gas phase reactors) and is also well known in the art.

Relatively higher density linear PE, typically in the range of 0.930 to 0.940 g/cm³, is sometimes referred to as medium density polyethylene (“MDPE”) and can be made in any of the above processes with each of the disclosed catalyst systems and, additionally, chrome catalyst systems. Again, this type of polyethylene has been commercially manufactured for a long time.

Polyethylene having a still greater density is high density polyethylene (“HDPE”), i.e., polyethylene having densities greater than 0.940 g/cm³, and are generally prepared with either Ziegler-Natta or chromium-based catalysts in slurry reactors, gas phase reactors or solution reactors. HDPE has been manufactured commercially for a long time (since the 1950's in slurry systems) and is well known in the art. “Medium-high molecular weight HDPE” is hereinafter defined as HDPE having a Melt Index (“MI”) ranging from about 0.1 g/10 min to about 1.0 g/10 min.

Very low density polyethylene (“VLDPE”) is a subset of LLDPE and is also known. VLDPEs can be produced by a number of different processes yielding polymers with different properties, but can be generally described as polyethylenes having a density typically from 0.890 or 0.900 g/cm³ to less than 0.915 g/cm³.

Nothing with regard to these definitions is intended by the applicant to be contrary to the generic definitions of these resins that are well known in the art. It should be noted, however, that mLLDPE may refer to a blend of more than one mLLDPE grades/types; HDPE may refer to a blend of more than one HDPE grades/types; LDPE may refer to a blend of more than one LDPE grades/types, etc. Thus, a reference to a “first mLLDPE” in the first layer will include Exceed 1018 as the first mLLDPE or could also include a blend of Exceed 1018 and Exceed 1012, each of which are commercially available from ExxonMobil Chemical Company.

If any of the resins is produced using a single-site catalyst, it is identified herein with an initial lower case “m”. For example, single-site catalyzed linear low density polyethylene manufactured in a gas phase reactor will be abbreviated “mLLDPE” hereinafter. As used herein, the terms “single-site catalyzed polymer” refers to any polymer, copolymer, or terpolymer, and, in particular, any polyolefin polymerized using a single-site catalyst and is used interchangeably with the term “metallocene catalyzed polymer”; wherein both “metallocene catalyzed polymer” and “single-site catalyzed polymer” are meant to include non-metallocene catalyzed single-site catalyzed polymers. As used herein, the term “Ziegler-Natta catalyzed polymer” refers to any polymer, copolymer, or terpolymer, and, in particular, any polyolefin polymerized using a Ziegler-Natta catalyst.

Molecular weight distribution (MWD), or polydispersity, is a well-known characteristic of polymers. MWD is generally described as the ratio of the weight average molecular weight (Mw) to the number average molecular weight (Mn). The measurement of MWD is described below; generally, the ratio Mw/Mn can be measured directly by gel permeation chromatography techniques. Many typical Ziegler-Natta catalyzed polyethylenes have an MWD of about 4±1, however, they may range up to an MWD of about 10. Single-site catalyzed polyethylenes or metallocene catalyzed polyethylenes generally have a lower MWD than the Zeigler-Natta catalyzed polyethylenes, typically approximately 3±1, preferably approximately 2.5±0.5. However, certain single-site catalyzed polyethylenes may also have higher MWD values. In one embodiment the single-site catalyzed polyethylene or the metallocene-catalyzed polyethylene will have an approximate MWD of about 5.5±1.

The mLLDPE, HDPE, MDPE and LDPE polyethylenes contemplated in certain embodiments of the present invention include ethylene homopolymers and/or ethylene alphα-olefin copolymers. By copolymers we intend combinations of ethylene and one or more alphα-olefins. In general the alphα-olefins comonomers can be selected from those having 3 to 20 carbon atoms, such as C₃-C₂₀ α-olefins or C₃-C₁₂ α-olefins. Suitable α-olefin comonomers can be linear or branched or may include two unsaturated carbon-carbon bonds (dienes). Two or more comonomers can be used, if desired. Examples of suitable comonomers include linear C₃-C₁₂ α-olefins, and α-olefins having one or more C₁-C₃ alkyl branches, or an aryl group. Particularly preferred comonomers are 1-butene, 1-hexene and 1-octene. Specific comonomer examples include propylene; 1-butene; 3-methyl-1-butene; 3,3-dimethyl-1-butene; 1-pentene; 1-pentene with one or more methyl, ethyl or propyl substituents; 1-hexene; 1-hexene with one or more methyl, ethyl or propyl substituents; 1-heptene; 1-heptene with one or more methyl, ethyl or propyl substituents; 1-octene; 1-octene with one or more methyl, ethyl or propyl substituents; 1-nonene; 1-nonene with one or more methyl, ethyl or propyl substituents; ethyl, methyl or dimethyl-substituted 1-decene; 1-dodecene; and styrene. Specifically, the combinations of ethylene with a comonomer may include: ethylene 1-butene; ethylene 1-pentene; ethylene 4-methyl-1-pentene; ethylene 1-hexene; ethylene 1-octene; ethylene decene; ethylene dodecene; ethylene, 1-butene, 1-hexene; ethylene, 1-butene, 1-pentene; ethylene, 1-butene, 4-methyl-1-pentene; ethylene, 1-butene, 1-octene; ethylene, 1-hexene, 1-pentene; ethylene, 1-hexene, 4-methyl-1-pentene; ethylene, 1-hexene, 1-octene; ethylene, 1-hexene, decene; ethylene, 1-hexene, dodecene; ethylene, propylene, 1-octene; ethylene, 1-octene, 1-butene; ethylene, 1-octene, 1-pentene; ethylene, 1-octene, 4-methyl-1-pentene; ethylene, 1-octene, 1-hexene; ethylene, 1-octene, decene; ethylene, 1-octene, dodecene; combinations thereof and the like permutations. It should be appreciated that the list of comonomers and combinations above are merely exemplary, and are not intended to be limiting.

If a comonomer is used then the monomer is generally polymerized in a proportion of 50.0-99.99, preferably 70-99 and more preferably 80-95 or 90-95 weight percent of monomer with 0.01-50, preferably 1-30 and most preferably 5-20, 5-10 mole percent comonomer. In one embodiment, the first polyethylene has a comonomer content of from about 5 to 15 wt. %, preferably from about 10 to 15 wt. % and the second polyethylene has a comonomer content ranging from about 15 to about 50 wt. %, preferably from about 20 to about 30 wt. %. The actual amount of comonomers will generally define the density range.

The Multi-Layer Film

Although the present invention is described below generally in terms of a three-layer film for purposes of convenience, the present invention encompasses multi-layer films with more than three layers. The multi-layer film is generally described in terms of: a first, outer or skin layer; a core or second layer; and a third, outer or skin layer, wherein the second layer is located between the first and third layers, with such designations being for reference only. It is understood that one or more layers may be present between the first and second layers and between the second and third layers. Additionally, a print layer or the like may be located on the surface of the first or third layer or both. Similarly, a fourth layer may be laminated to the surface of the first or third layer. The number of layers between the first and second layers and between the second and third layers may be the same or different. The composition of any layer or layers between the first and second layer may be the same or different from the composition of any layer or layers between the second and third layers. Additionally, the present invention includes a two-layer film, comprising only the first layer and the second layer.

In one embodiment according to the present invention, the multi-layer film comprises a first layer comprising at least about 80 wt % of a first mLLDPE having a density ranging from about 0.910 to 0.930 g/cm³ based on the total weight of the first layer; a second layer comprising from about 60 wt % to about 90 wt % of an HDPE having a density ranging from about 0.940 g/cm³ to about 0.965 g/cm³ and a melt index ranging from at least about 0.1 g/10 min to about 1.0 g/10 min, and from about 40 wt % to about 10 wt % of a second mLLDPE, having a density ranging from about 0.910 to 0.930 g/cm³ and a melt index ranging from about 0.2 to 3.5 g/10 min, and optionally from about 0 to 10 wt % of a second LDPE, wherein the wt % of the HDPE, the second LDPE and the second mLLDPE is based on the total weight of HDPE, the second LDPE and the second mLLDPE; and a third layer comprising at least about 80 wt % of a third mLLDPE based on the total weight of the third layer. The first mLLDPE, the second mLLDPE and the third mLLDPE may be the same or different and each may individually comprise a blend of one or more mLLDPE's. The HDPE may likewise comprise a blend of one or more HDPE's and, similarly, the LDPE may comprise a blend of one or more LDPE's.

In another embodiment according to the present invention, a multi-layer film comprises: a first layer comprising at least about 80 wt % of a first mLLDPE having a density of from about 0.910 to 0.930 g/cm³ based on the total weight of the first layer; and a second layer comprising from about 60 to 90 wt % of an HDPE, having a density ranging from about 0.940 to 0.965 g/cm³ and a melt index ranging from at least about 0.1 g/10 min to about 1.0 g/10 min, and from about 40 to 10 wt % of a second mLLDPE, having a density ranging from about 0.910 g/cm³ to about 0.930 g/cm³ and a melt index ranging from about 0.2 g/10 min to about 3.5 g/10 min; and, optionally, from about 0 to 10 wt % of a second LDPE, wherein the wt % of the HDPE, the second LDPE and the second mLLDPE is based on the total weight of the HDPE, the second LDPE and the mLLDPE in the second layer. The first mLLDPE and the second mLLDPE may be the same or different.

In one embodiment, the first layer further comprises less than about 20 wt % of a first LDPE, preferably less than about 10 wt % of the first LDPE and more preferably less than or equal to about 5 wt %, wherein the wt % is based on the total weight of the first mLLDPE and the first LDPE. In another embodiment, the third layer further comprises less than about 20 wt % of a third LDPE, preferably less than about 10 wt % of the third LDPE and more preferably less than or equal to about 5 wt % of the third LDPE, wherein the wt % is based on the total weight of the third mLLDPE and the third LDPE.

In one embodiment each of the first and third layers of the multi-layer film independently comprises about 0.5 to 10 wt %, preferably from about 3 to 5 wt %, of the first and third LDPE, respectively, wherein the wt % is based on the total weight of the mLLDPE and LDPE in the layer. In a more preferred embodiment, the first and third layers independently comprise from about 5 wt %±2 wt % of the first and third LDPE's, respectively, wherein the wt % is based on the total weight of the mLLDPE and LDPE, in the first and third layers, respectively. In a more preferred embodiment, the first layer independently comprises 5±2 wt % of the first LDPE wherein the wt % is based on the total weight of the first layer.

In an embodiment according to the invention, the second layer comprises from about 65 to 90 wt % of the HDPE and from about 35 to 10 wt % of the second mLLDPE; preferably from about 65% to 85 wt % of the HDPE and from about 35 to 15 wt % of the second mLLDPE; also preferably from about 60 to 80 wt % of the HDPE and from about 40 to 20 wt % of the second mLLDPE; more preferably from about 70 to 85 wt % of the HDPE and from about 30 to 15 wt % of the second mLLDPE, and yet more preferably from about 70 to 80 wt % of the HDPE and from about 30 to 20 wt % of the second mLLDPE; and yet even more preferably from about 70 to 75 wt % of the HDPE and from about 30 to 25 wt % of the second mLLDPE, wherein the wt % of the HDPE and the second mLLDPE is based on the total weight of the HDPE and the second mLLDPE in the second layer.

In one embodiment according to the present invention, the melt index (MI) of the HDPE ranges from about 0.10 to 1.0 g/10 min, preferably from about 0.10 to 0.40 g/10 min, and more preferably from about 0.10 to 0.3 g/10 min and yet more preferably from about 0.15 to 0.30 g/10 min. These MI's are indicative of medium-high molecular weights.

In another embodiment according to the present invention, the density of the HDPE ranges from about 0.945 g/cm³ to about 0.960 g/cm³, preferably from about 0.950 g/cm³ to about 0.960 g/cm³, preferably from about 0.945 to 0.955 g/cm³, and more preferably from about 0.950 g/cm³ to about 0.955 g/cm³.

In one embodiment the second mLLDPE of the second layer has a MI ranging from about 0.2 to 3.5 g/10 min and preferably from about 0.7 to 2.7 g/10 min and more preferably from about 0.5 to 1.5 g/10 min. In another embodiment of the present invention the second mLLDPE of the second layer has a density ranging from about 0.910 g/cm³ to about 0.930 g/cm³ and preferably from about 0.912 g/cm³ to about 0.927 g/cm³ and most preferably from about 0.915 g/cm³ to about 0.920 g/cm³. The density and the melt index of the second mLLDPE in the second layer may be the same or different as the first and third mLLDPE's in the first and third layers.

In yet another embodiment of the present invention, the second layer optionally contains a second LDPE having a density of from 0.915 to 0.940 g/cm³, and an MI of from 0.1 to 2.0 g/10 min. The second LDPE may be present in an amount of up to 10 wt %, preferably from about 2 to 10 wt %. If the second LDPE is present in an amount of 10 wt %, for example, the proportions of the HDPE and second mLLDPE present may be reduced such that the HDPE would be present in an amount ranging from 54 to 81 wt % and the second mLLDPE is present in an amount ranging from 36 to 9 wt % based on the weight of the HDPE, the second mLLDPE and the second LDPE in the second layer.

Additionally, additives such as colorants or UV stabilizers may be present in the second layer of the invention. These additives will typically be added to the polyethylene resin of the second layer as a masterbatch using a carrier of a compatible polyethylene resin. Any such addition of the masterbatch would not be reflected in the weight percentages reported in the second layer and would be additional material raising the total weight percent of the second layer over 100 wt %.

Similarly, additives such as processing aids or antiblock agents may be present in either or both of the first and third layers. These additives are also typically added to the polyethylene resins of the respective layer as a masterbatch using a carrier of a compatible polyethylene resin. Also, the addition of such masterbatches may not be reflected in the weight percentages reported in the first and third layers, as applicable, and, therefore, the total weight percent of the first and third layers may also be raised over 100 wt %.

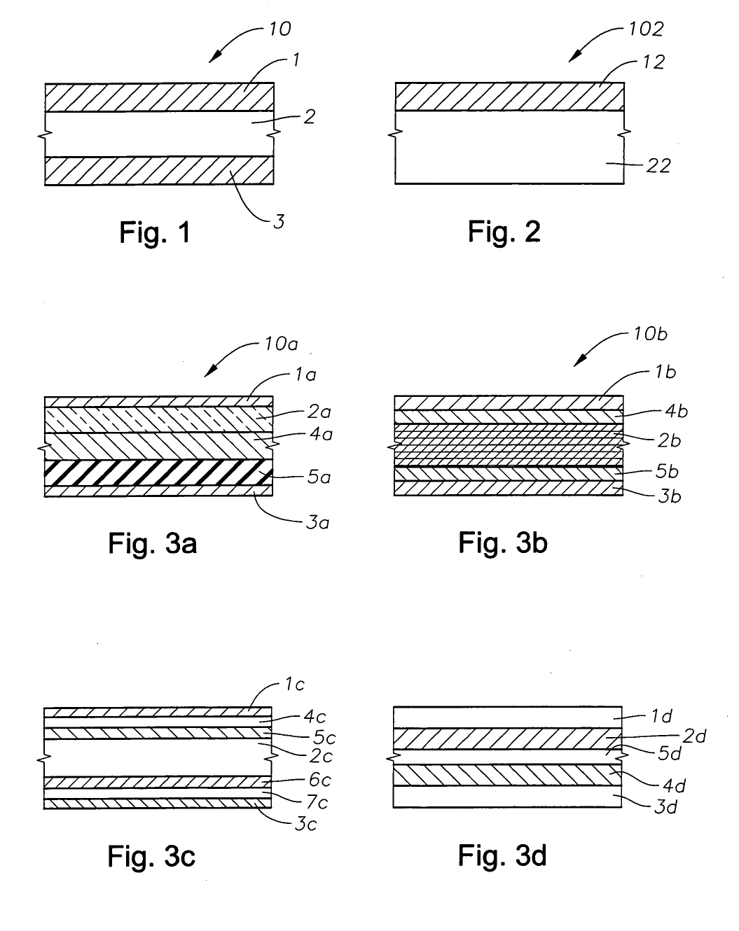

The multi-layer film 10 of the present invention is depicted in FIG. 1 and has a first layer 1, a second layer 2 and an third layer 3 that have a relative thickness ratio ranging from about 1:1:1 to about 1:4:1, respectively. Preferably, the thickness ratio of the first, second, and third layer of the present invention is from about 1:1:1 to about 1:2:1. In another embodiment the multi-layer film has a first, second, and third layer having a relative thickness ratio ranging from about 1:2:1 to about 1:4:1. As shown in FIG. 1, the thickness ratio of the first, second and third layers is 1:2:1. Note that the density of the HDPE in the second layer will have an effect on the desired relative thickness of the second layer. The lower the density of the HDPE selected for the second layer, the thicker the second layer must be relative to the overall structure. Alternatively, a second layer of the same relative thickness may be used with the lower density HDPE if a lower percentage of mLLDPE is utilized in the blend of the second layer, such that the overall crystallinity is not adversely affected.

In another embodiment shown in FIG. 2, the multi-layer film 102 has a first layer 12 and a second layer 22 having a relative thickness ratio ranging from about 1:1 to about 1:4 and preferably from about 1:1 to about 1:2. As shown in FIG. 2, the relative thickness ratio of the first layer to the second layer is 1:2. In another embodiment the multi-layer film has a first and a second layer having a relative thickness ratio ranging from about 1:2 to about 1:4. There may be one or more layers of the same or different composition between the first and second layers.

There may be one or more layers of the same or different composition between the first and second layers or between the second and third layers. As shown in FIG. 3a, there is depicted a multi-layer film structure 10a having a first layer 1a, a second layer 2a and an third layer 3a. Intercalated between the second and third layers are a fourth layer 4a and a fifth layer 5a. The relative thickness ratios of the first, second, third, fourth and fifth layers, respectively, are depicted as 1:3:3:3:1. It is clear to one of ordinary skill in the art that layers 4a and 5a could alternatively be intercalated between the first and second layer. It is also clear to one of skill in the art that the relative ratios of the layers could vary such that the stiffness, sealing, toughness and optical criteria are met and provide the advantageous downguaging and/or faster processing time.

As shown in FIG. 3b, a multi-layer film structure 10b comprises a first layer 1b, a second layer 2b and a third layer 3b and further has a fourth layer 4b intercalated between the first 1b and second 2b layers and a fifth layer 5b between the second 2b and third 3b layers. The relative thickness ratios of the first, second, third, fourth and fifth layers are, respectively, 1:1:3:1:1. It would be apparent that these relative ratios of the layers are merely exemplary and one of skill in the art would be able to identify additional thickness ratios that would provide the ability to downgauge and/or run the FFS lines more quickly while still attaining the stiffness, toughness, creep resistance optical and sealing properties demanded of the packaging materials of the present invention to prevent bag breakage when dropped.

Alternatively, the present invention also comprises the multi-layer film structure of FIG. 3c. FIG. 3c depicts a film structure 10c comprising a first layer 1c, a second layer 2c and a third layer 3c. Between the first and second layers are shown a fourth layer 4c and a fifth layer 5c. Between the second and third layer are shown a sixth layer 6c and a seventh layer 7c. The thickness ratio of the first, second, third, fourth, fifth, sixth and seventh layers (1c:2c:3c:4c:5c:6c:7c) is depicted as being 1:2:1:1:1:1:1. The ordinary artisan will readily understand that alternative thickness ratios may also be employed so long as the appropriate stiffness, crystallinity, MD Elmendorf Tear Strength and sealability are maintained.

As shown in FIG. 3d, a multi-layer film structure 10d comprises a first layer 1d, a split second layer 2d, 5d and a third layer 3d and further has a fourth layer 4d intercalated between the second layer 2d and second layer 5d. The relative thickness ratios of the first, second 2d, second 5d, third, and fourth layers are, respectively, 1:1:1:1:1. It would be apparent that these relative ratios of the layers are merely exemplary and one of skill in the art would be able to identify additional thickness ratios that would provide the ability to downgauge and/or run the FFS lines more quickly while still attaining the stiffness, toughness, creep resistance, optical and sealing properties demanded of the packaging materials of the present invention to prevent bag breakage when dropped.

In one embodiment the total film thickness ranges from about 50 microns to about 150 microns, preferably from about 75 microns to about 125 microns, and more preferably from about 90 microns to about 110 microns. One embodiment has a total film thickness of about 100 microns.

In one embodiment the multi-layer film is has a seal time less than about 1 sec, preferably less than or equal to about 0.7 sec, more preferably less than or equal 0.5 sec, and yet more preferably equal to or less than 0.3 sec when contacted by a sealing bar at a temperature ranging from about 120° C. to about 220° C. In one embodiment the multi-layer film is has a seal time less than about 1 sec, preferably less than or equal to about 0.7 sec, more preferably less than or equal 0.5 sec, and yet more preferably equal to or less than 0.3 sec when contacted by a sealing bar at a temperature ranging from about 120° C. to about 170° C. In another embodiment the multi-layer film has a seal time less than about 1 sec, preferably less than or equal to about 0.7 sec, more preferably less than or equal 0.5 sec, and yet more preferably equal to or less than 0.3 sec when contacted by a sealing bar at a temperature ranging from about 130° C. to 160° C.

The multi-layer film is typically extruded or blown in a tubular form by any conventional method. The packaging forming processes include, but are not limited to, tubular FFS; vertical form, fill and seal (VFFS) starting from flat film; and processes using pre-fabricated bags. In one embodiment according to the present invention, the tubular multi-layer film is fabricated to form a package, for example, a heavy duty sack, on a form, fill and seal machine. Typically, one end of a tubular film is heat sealed to form an open package. The desired contents, typically a powdered material or a granular material, are inserted into the open package and the open end is typically heat sealed to contain or encapsulate the desired contents in the package, thereby forming a filled package. The heat sealing in the case of a heavy duty sack is often accomplished with an impulse sealing apparatus rather than a thermal bar sealing apparatus, however, either may be utilized. If starting from a flat film, longitudinal sealing to form the tubular film may take the form of a fin seal, in which the film is folded back on itself such that the first layer contacts the first layer (or the third layer contacts the third layer), or a lap seal, in which one edge of the film overlaps the surface of another side of the film such that the first layer contacts the third layer.

The heavy duty sacks may be produced on equipment including, but not limited to, vertical form fill and seal equipment. Vertical form fill and seal equipment is well known to those of skill in the packaging arts. The following documents disclose a variety of equipment suitable for vertical form fill and seal: U.S. Pat. No. 2,956,383; U.S. Pat. No. 3,340,129; U.S. Pat. No. 3,611,657; U.S. Pat. No. 3,703,396; U.S. Pat. No. 4,103,473; U.S. Pat. No. 4,506,494; U.S. Pat. No. 4,589,247; U.S. Pat. No. 4,532,752; U.S. Pat. No. 4,532,753; U.S. Pat. No. 4,571,926; and Great Britain Patent Specification No. 1 334 616, each of which is hereby incorporated in its entirety by reference.

Test Methods Employed in Examples/Discussion

Gel Permeation Chromatography

Gel Permeation Chromatography (“GPC”) may be used to determine MWD as follows. A WATERS 150C GPC chromatograph equipped with mixed-pore size columns for molecular weight measurements may be employed. Size exclusion chromatography may be carried out, for example, by using a 25 cm long preliminary column from Polymer Labs having a 50 Å nominal pore size, followed by three 25 cm long Shodex A-80 M/S (Showa) columns to affect a molecular weight separation for linear ethylene polymer from about 200 to 10,000,000 Daltons. All columns will be packed with a porous packing material, such as poly(styrene-divinyl benzene) packing. A solvent, such as 1,2,4,-trichlorobenzene, may be used to prepare the polymer solutions and the chromatographic eluent. Measurements are made at a pre-determined temperature, for example, 140±0.2° C. The analog signals from the mass and viscosity detectors would then be collected into a computer system. The collected data may then be processed using standard software commercially available from several sources (Waters Corporation and Viscotek Corporation) in order to obtain molecular weight distribution uncorrected for long chain branching. Calibration may use standard techniques known in the art such as the broad MWD calibrant method and with a linear polymer as the calibrant. (See W. W. Yau, J. J. Kirkland and D. D. Bly, Modem Size-Exclusion Liquid Chromatography, Wiley, 1979, p. 289-313.) For the latter, two MW related statistics such as number and weight average MW values must be known for the polymer calibrant. Based on the MW calibration, elution volume will then be converted to molecular weight for the assumed linear ethylene polymer.

MFR or Melt Index

MFR is measured according to ASTM D-1238 test method, at 190° C. and 2.16 kg load, and is expressed as dg/min or g/10 min. It is also referred to as the Melt Index (MI). The I₂₁ is measured under the same conditions except that a 21.6 kg load is used.

The ratio of I₂₁/I₂ is known as the melt index ratio (MIR) and for the purposes of this patent specification the ratio is also defined to be melt flow ratio (MFR). MIR is generally proportional to the MWD.

Density

Density in g/cm³ is determined in accordance with ASTM 1505, based on ASTM D-1928, procedure C, plaque preparation. A plaque is made and conditioned for one hour at 100° C. to approach equilibrium crystallinity, measurement for density is then made in a density gradient column.

TD and MD Elmendorf Tear Test

In blown or cast films the initial notch in the sample is made parallel with either the machine or transverse direction. By convention the testing direction is defined as the axis with which the notch is aligned. At the start of the Elmendorf test one sample tab is gripped in a fixed jaw while the other is gripped in a movable jaw attached to a pendulum. When the pendulum is released it swings down, taking the movable grip with it, subjecting the sample to a complex “trouser leg” tear, absorbing energy as it does so. The Elmendorf tear strength (ETS) is reported as the force required to rupture the sample in g/mil or N/m and is measured using ASTM D-1922.

Dart Impact Strength

Dart impact strength is measured in g/mil (g/25.4 μm) per ASTM D-1709.

MD and TD Tensile at Yield

MD and TD Tensile at Yield (N/15 mm) are measured according to ASTM D-882.

MD and TD Ultimate Tensile at Yield

MD and TD Ultimate Tensile at Yield (N/15 mm) are measured according to ASTM D-882.

MD and TD 1% Secant Modulus

MD and TD 1% Secant Modulus (N/15 mm) are measured per ASTM D-882.

Seal Strength

Seal Strength (N/μm for 15 mm wide sample) is measured per ASTM D-882. Sealing was performed with 80 μm Teflon sheet between the film and the seal bar for 0.5 sec at 200 MPa with a seal bar having a width of 5 mm and a length of 50 mm on a film sample having a width of 30 mm.

Peak Puncture Force

The peak puncture force, reported in newtons (N) is measures the low speed puncture properties of plastic film samples. The method provides load versus deformation response under multi-axial deformation conditions at a fixed relatively low test speed (500 mm/min) to mimic the conditions under which the heavy duty sack is exposed to sharp objects during handling. A piston with a standard probe fixed to a load cell is pushed through a film sample in a circular sample holder with a 90 mm diameter until the film punctures and breaks. The load is measured on the load cell and the deformation is measured by the travel of the cross-head.

Hot Stage Microscopy

This procedure permits the observation of melting and crystallization characteristics of polymers below 300° C. A Leitz microscope is used with a Mettler FP 82HT hot stage oven and a Mettler FP 90 central processor. A prepared sample is place on the FP82 hot stage. The start temperature is set and the sample allowed to equilibrate to the start temperature. The sample is heated to 300° C. at a rate of 10° C./min. The sample is viewed through the microscope during the heating procedure. The sample may also be viewed through a JVC color camera with images saved and processed with a Lablan PC with Image Compact software.

Bag Drop Resistance

Bag drop resistance testing was carried out by dropping a test resin bag from a 2 m platform three times—once on a face, once on an edge, and once on either the top or bottom. Bags were filled on two types of Haver & Boecker FFS packaging lines: an Alpha line running at a bagging speed of 500 bags per hour and a Delta line running at a bagging speed of 2200 bags per hour. If a film manufactured into a bag manufactured and filled on the Alpha line did not pass, the bag was not tested for the Delta line. The test was run three times for a given film formulation on a given FFS packaging line. If all three test bags did not break in any of the tests, it was noted to be “OK.” If any of the test bags for a particular film formulation did break, the film was noted “NOK” (not OK).

Various desirable characteristics of packaging are hereinafter described with exemplary reference to performance characteristics useful in resin bags. A typical resin bag is capable of receiving, holding and carrying 50 lbs (22.7 kg) of resin pellets.

Stiffness is important for filling bags. A bag's MD 1% Secant Modulus is a good measure of its stiffness. Resin bags need a minimum MD 1% Secant Modulus of 219 lbs per inch (576 N/15 mm) of sidewall (40,000 psi (276 MPa) as measured on a 5.5 mil (140 μm) film). Bags with lower modulus sag in some FFS bag machines, which makes them difficult to seal.

Lifting ability is important for bags; for example, when picking up and carrying resin pellets, it is helpful if the bag does not break. The lifting ability of a bag is determined by its MD Tensile Strength at Yield. The minimum MD Tensile Strength at Yield needed for resin bags with 42-inch (107 cm) girths (15-inch (38 cm) wide bag with 3-inch (7.6 cm) gussets) to pick up 50 lbs (22.7 kg) of resin pellets is 10 lbs (per inch of the bag's sidewall (2,000 psi (13.8 MPa) as measured on a 5 (127 μm) mil film).

Creep resistance is important for preventing resin bags from creeping during transport and storage. A bag's creep resistance is related to its TD Tensile Strength at Yield. The minimum TD Tensile Strength at Yield needed to keep resin bags from creeping is 2,000 psi (13.8 MPa) for a 5 mil (127 μm) film.

Tear resistance is important to prevent bags from ripping when caught on sharp or irregular objects. The MD Elmendorf Tear of a bag is a good measure of its tear resistance. Resin bags need a minimum MD Elmendorf Tear of 500 g (100 g/mil (3.9 g/μm) for a 5 mil (127 μm) film). The higher the MD Elmendorf Tear value, the better the bag is.

Impact resistance is important to achieving packaging integrity, i.e., fewer bag breaks. A bag's dart drop performance is a good measure of its impact resistance. Resin bags need a minimum dart drop value of 500 g (100 g/mil (3.9 g/μm) for a 5 mil (127 μm) film). The higher the dart drop value, the better the bag is.

Puncture resistance is important to prevent initiating holes in bags caught on sharp or irregular objects. A hole can result in a torn bag and product loss. A bag's Puncture Force and Energy measure its puncture resistance. Resin bags need a minimum Puncture Force of 30 lbs (133.6 N) (6 lbs/mil (1.05 N/μm) for a 5 mil (127 μm) film) and minimum Puncture Energy of 60 in-lbs (6.8 J) (12 in-lbs/mil (0.054 J/μm) for a 5 mil (127 μm) film).

Bag drop resistance is also a very important property. It measures the ability of a bag to withstand being dropped without breaking thus losing product and creating spillage that requires manpower to clean. This test may be thought of as a test of the combined properties: if the seal strength is sufficient, the bag will not break along the seams; if the MD Elmendorf Tear is sufficient, the bag will not break in the machine direction; if the TD Tear is sufficient, the bag will not break in the transverse direction. Puncture resistance and dart drop will be important during the filling process. Note that the right combination of these properties is needed for a successful packaging material.

As mentioned previously, current commercial films balance these properties with resulting costs in terms of the ability to downgauge and/or the speed at which the film manufacturing lines can be run. With the multi-layer film present invention, faster film line speeds and/or downgauging may be accomplished while maintaining the product properties.

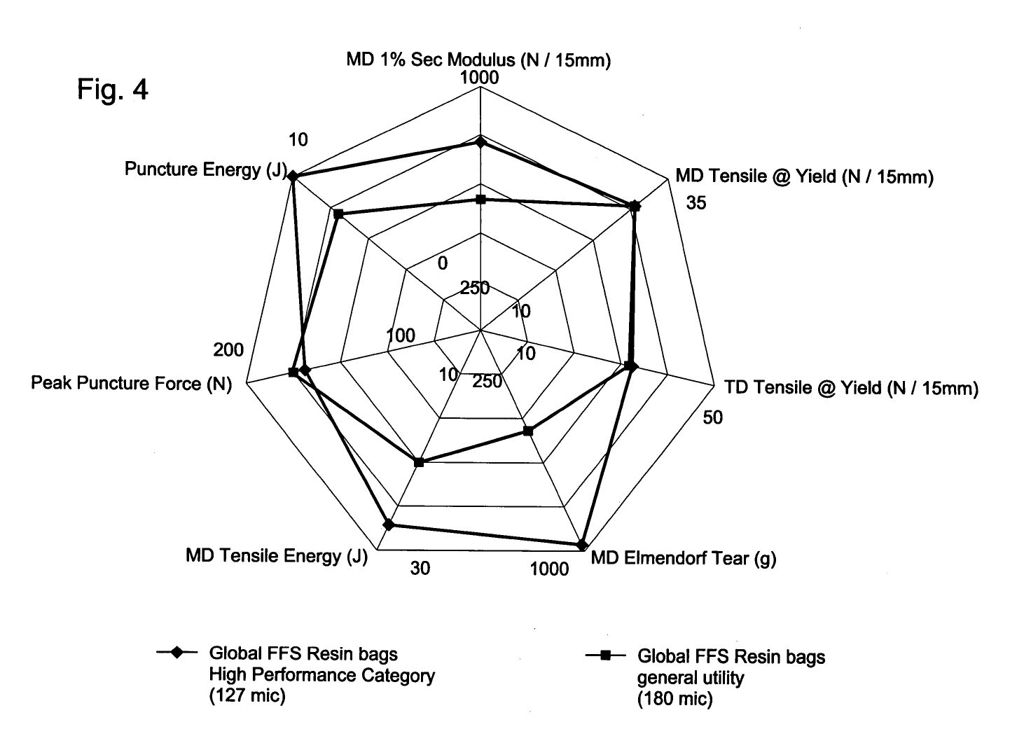

The terms “standard resin high performance” and “standard resin general utility” refer to categories of films that have the set of values qualitatively listed in Table 1, depicted quantitatively in FIG. 4 and listed quantitatively in Table 2. Commercial bags were obtained and tested for the characteristics; each of the values shown in FIG. 4 and listed in Table 2 represents the average value of the commercial bags. The resin content of the bags was determined using Melt index and ¹H NMR methods. The bag structures, i.e., mono-layer or coextruded, were determined using Hot Stage Microscopy.

TABLE 1
Relative Performance of FFS Resin Bags

| Bag | MD 1% | Tensile @ Yield | | MD Elmendorf | MD Tensile Energy | Puncture | |
|---|---|---|---|---|---|---|---|
| Description | Secant | MD | TD | Tear | (Impact Resistance) | Force | Energy |
| High | ++ | ++ | ++ | ++ | ++ | ++ | ++ |
| Performance | | | | | | | |
| General | + | ++ | ++ | + | + | ++ | + |
| Utility | | | | | | | |

TABLE 2

| | | Global FFS | Global FFS |
|---|---|---|---|
| | | Resin bags | Resin bags |
| | Test | high performance | general utility |
| ATTRIBUTE (UNIT) | method | (127 μm) | (180 μm) |
| MD 1% Sec Modulus | ASTM | 789 | 570 |
| (N/15 mm) | D882 | | |
| MD Tensile @ Yield | ASTM | 29.0 | 29.2 |
| (N/15 mm) | D882 | | |
| TD Tensile @ Yield | ASTM | 32.2 | 31.3 |
| (N/15 mm) | D882 | | |
| MD Elmendorf Tear | ASTM | 977 | 491 |
| (g) | D1922 | | |
| MD Tensile Energy | ASTM | 27.2 | 20 |
| (J) | D882 | | |
| Peak Puncture | EMC | 168 | 176 |
| Force (N) | | | |
| Puncture Energy | EMC | 10.0 | 7 |
| (J) | | | |

As can be seen from this data, both high performance and general utility bags require approximately the same load bearing capability and creep resistance (MD and TD Tensile at Yield) and Peak Puncture Force. However, in order to meet the criteria for high performance bags, the bags must have greater stiffness, tear resistance, impact, and puncture resistance (MD 1% Secant Modulus, MD Elmendorf Tear, MD Tensile Energy and Puncture Energy) than a general utility bag. Note that the high performance bags are better despite the downgauging of the film measured. Also of note is that our testing indicated that the high performance bags were manufactured using coextruded multi-layer films unlike the mono-layer general utility structures.

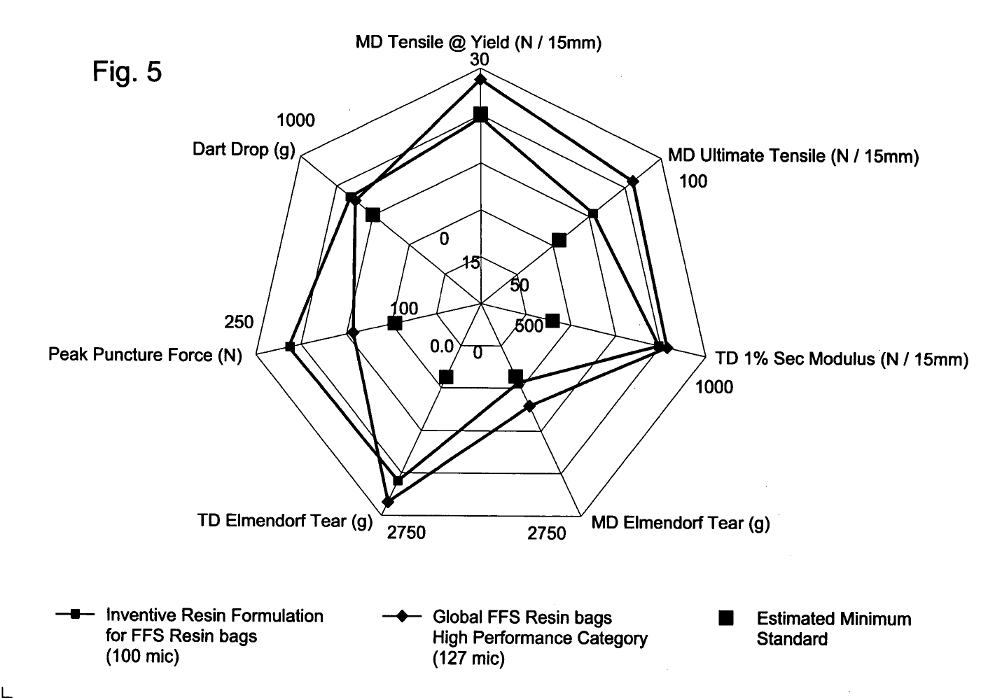

In one embodiment the multi-layer film of the present invention has an equal or improved value, compared to the high performance film as described above, for at least one of MD tensile at yield, MD ultimate tensile at yield, TD 1% Secant modulus, MD Elmendorf tear, TD Elmendorf tear, peak puncture force or dart drop. The multi-layer film of the present invention preferably has an equal or improved value for one of the properties compared to a standard high performance film about 10% thicker, more preferably about 20% thicker. In another embodiment the multi-layer film has an equal or improved value, compared to the standard high performance film as described below, for more than one of MD tensile at yield, MD ultimate tensile at yield, TD 1% Secant modulus, MD Elmendorf tear, TD Elmendorf tear, peak puncture force and dart drop, preferably having the equal or improved value compared to a standard high performance film about 10% thicker, more preferably about 20% thicker than a multi-layer film according to the present invention, as shown in FIG. 5.

### EXAMPLES

The present invention will now be exemplified with reference to Table 3. Six multi-layer films were blown at a rate of 150 kg/hr on a Windmueller & Hoelscher coextrusion film line, having a 160 mm die, a die gap of 1.4 mm, a blow up ratio of approximately 2.1:1. Examples 1-5 are examples in accordance with the present invention while Examples 6 and 7 are comparative examples that do not include a mLLDPE in the second layer: Example 6 instead includes a Zeigler-Natta catalyzed LLDPE; and Example 7 instead is HDPE alone. Note also that Example 5, while marginally within the scope of the invention comprises Elite 5100G, commercially available from The Dow Chemical Company, that is believed to include both a Zeigler-Natta catalyzed moiety and a metallocene catalyzed moiety. The effective amount of mLLDPE is believed to be approximately one-half the wt % of the Elite 5100G resin (approximately 10 wt % instead of the reported 20 wt %).

TABLE 3

| | | | | | Total | | Sample |
|---|---|---|---|---|---|---|---|
| | | | | Layer | thickness | | width |
| Example | Layer A (Outer) | Layer B (Core) | Layer C (Inner) | distr. | (μm) | B.U.R. | (mm) |
| 1 | Exceed 1018CA, 90% | HTA002, 70% | Exceed 1018CA, 90% | 1/2/1 | 100 | 2.1:1 | 530 |
| | LD150BW, 8% | Exceed1018CA, 22% | LD150BW, 8% | | | | |
| | F 15, 2% | 8% white B8750 | F 15, 2% | | | | |
| 2 | Exceed 1018CA, 90% | HD 7845.30, 80% | Exceed 1018CA, 90% | 1/2/1 | 100 | | 530 |
| | LD150BW, 9% | Exceed1018CA 15% | LD150BW, 8% | | | | |
| | F 15, 1% | LD150BW, 5% | F 15, 2% | | | | |
| 3 | Exceed 1018CA, 90% | HD 7845.30 70% | Exceed 1018CA, 90% | 1/2/1 | 100 | 2.2:1 | 547 |
| | LD150BW, 9% | Exceed1018CA 30% | LD150BW, 8% | | | | |
| | F 15, 1% | | F 15, 2% | | | | |
| 4 | Exceed 1018CA, 95% | HYA600, 80% | Exceed 1018CA 95% | 1/2/1 | 100 | 2.1:1 | 530 |
| | LD150BW, 3% | Exceed1018CA 20% | LD150BW, 3% | | | | |
| | F 15, 2% | | F 15, 2% | | | | |
| 5 | Elite 5100G, 95% | HTA002, 80% | Elite 5100G 95% | 1/2/1 | 100 | 2.1:1 | 530 |
| | LD150BW, 3% | Elite5100G, 20% | LD150BW, 3% | | | | |
| | F 15, 2% | | F 15, 2% | | | | |
| Comp. | LL1001XV, 95% | HTA002, 80% | LL1001XV, 95% | 1/2/1 | 100 | 2.1:1 | 530 |
| 6 | LD150BW, 3% | LL1001XV, 20% | LD150BW, 3% | | | | |
| | F 15, 2% | | F 15, 2% | | | | |
| Comp. | Exceed 1018CA | HTA002, 100% | Exceed 1018CA, 95% | 1/2/1 | 100 | 2.2/1 | 547 |
| 7 | (1.0 MI/.9) | | LD150BW, 3% | | | | |
| | LD150BW, 4% | | 2% F 15 | | | | |
| | 1% F 15 | | | | | | |

Wherein the following resins were utilized:
NX 00152 (HDPE 0.15 MI/0.952d), commercially available from ExxonMobil
HD 7845.30 (HDPE 0.45 MI/0.958d), commercially available from ExxonMobil
HYA600 (HDPE 0.3 MI/0.954d), commercially available from ExxonMobil
LL1001XV (LLDPE 1.0 MI/0.918d), commercially available from ExxonMobil
Exceed 1018CA (mLLDPE 1.0 MI/0.918d), commercially available from ExxonMobil
LD150BW (LDPE 0.75 MI/0.923d), commercially available from ExxonMobil
Elite 5100G (mLLDPE 1.0 MI/0.920d), commercially available from The Dow Chemical Company
F 15 (Anti-Block-Masterbatch having 15% silica in an LDPE carrier), commercially available from A. Schulman

The films blown in Examples 1-5 and Comparative Example 6 were tested for their seal strength (Table 4) and Examples 1-5 and Comparative Examples 6 and 7 were tested for their performance according to the characteristics listed in Table 5. Of particular note is that the films of Comparative Examples 6 and 7 do not have the MD Elmendorf Tear Strength of the films of the current invention. Thus, Comparative Examples 6 and 7 do not pass the Bag Drop Resistance test, as reported later. Additionally, while the Dart Drop Impact (Method A/Face) values were similar for the Comparative Example 7 and Example 5, it should be noted that the mLLDPE of the second layer was effectively halved because of the bimodal nature of the Elite resin and it is also believed that the blending into the HDPE of the remainder of the second layer may also be compromised because of the bimodal nature of the Elite resin.

TABLE 4
Seal Strength (N/15 mm):

| Sealing | | | | | | |
|---|---|---|---|---|---|---|
| Temp | Example | | | | | |
| (deg C.) | 1 | 2 | 3 | 4 | 5 | Comparative 6 |
| 100 | 0.0 | 0.0 | 0.0 | 0.0 | 0.5 | 0 |
| 105 | 0.8 | 1.4 | 0.9 | 0.6 | 1.5 | 0.29 |
| 110 | 5.4 | 23.3 | 22.5 | 3.7 | 4.2 | 0.46 |
| 115 | 25.8 | 25.5 | 24.0 | 26.2 | 24.0 | 1 |
| 120 | 26.6 | 26.0 | 24.4 | 26.1 | 26.7 | 2.44 |
| 130 | 31.6 | 26.8 | 25.5 | 26.2 | 31.9 | 27.97 |
| 150 | 32.3 | 27.5 | 26.9 | 28.4 | 33.6 | 30.96 |

TABLE 5

| | | | Example | | | | | | |
|---|---|---|---|---|---|---|---|---|---|
| | | Test Method | | | | | | Comparative | Comparative |
| Property | Unit | Description | 1 | 2 | 3 | 4 | 5 | 6 | 7 |
| 10% Offset yield MD | MPa | ASTM D882 | 16 | 16.9 | 15.8 | 16.1 | 16.5 | 16.8 | 18.5 |
| 10% Offset yield TD | MPa | ASTM D882 | 16.6 | 18.1 | 17 | 17 | 17.7 | 17.3 | 19 |
| Tensile at Break MD | MPa | ASTM D882 | 44.7 | 42.5 | 47.8 | 45.5 | 41.4 | 38.8 | 51.6 |
| Tensile at Break TD | MPa | ASTM D882 | 40 | 38.7 | 45.1 | 39.6 | 37.6 | 33.9 | 45.6 |
| Elongation at Break MD | % | ASTM D882 | 661 | 761 | 674 | 706 | 644 | 702 | 637 |
| Elongation at Break TD | % | ASTM D882 | 713 | 701 | 687 | 693 | 733 | 894 | 680 |
| Energy to Break MD | mJ/mm³ | ASTM D882 | 157 | 175 | 150 | 158 | 148 | 164 | 173 |
| Energy to Break TD | mJ/mm³ | ASTM D882 | 136 | 140 | 146 | 134 | 139 | 163 | 149 |
| Tensile Modulus (1% sec) MD | MPa | ASTM D882 | 488 | 512 | 445 | 451 | 464 | 467 | 535 |
| Tensile Modulus (1% sec) TD | MPa | ASTM D882 | 532 | 619 | 515 | 520 | 577 | 582 | 647 |
| Tensile Modulus (1% sec) AVG | MPa | ASTM D882 | 510 | 566 | 480 | 486 | 521 | 525 | 591 |
| Elmendorf Tear Strength MD | g/μ | ASTM D1922 | 6.0 | 6.4 | 9.0 | 5.5 | 4.4 | 1.8 | 3.6 |
| Elmendorf Tear Strength TD | g/μ | ASTM D1922 | 21.7 | 16.0 | 18.4 | 17.8 | 24.0 | 16.9 | 17.1 |
| Dart Drop | g/μ | ASTM D1709 | 3.42 | 1.87 | 4.15 | 2.88 | 1.08 | 0.6 | 5.2 |
| Impact(MethodA/Crease) | | | | | | | | | |
| Dart Drop Impact(MethodA/Face) | g/μ | ASTM D1709 | 5.5 | 5.37 | 5.35 | 5.12 | 2.3 | 1.31 | 2.4 |
| Tensile Creep TD (5 hrs, 1 kg, 50° C.) | % | | 45 | na | 40 | 41 | 59 | 54 | 27 |

In addition, seal strength properties were measured. Examples 1 and 5 had the best seal strength. Lastly, Examples 1-7 were subjected to the Bag Drop Resistance test, as shown in Table 6. Of all the Examples, only Example 1 passed the Bag Drop Resistance test on the high speed (Delta) lines. Thus, it can be seen that particular combinations of properties, namely: high seal strength combined with high tear strength, high dart impact and good resistance to creep, result in superior packaging materials suitable for use as heavy duty sacks.

TABLE 6

| Bag Drop | Example | | | | | | |
|---|---|---|---|---|---|---|---|
| Resistance Test | 1 | 2 | 3 | 4 | 5 | 6 | 7 |
| Alpha FFS line at | na | NOK | OK | na | na | na | NOK |
| 500 bags/h | | | | | | | |
| Delta FFS line at | OK | na | NOK | NOK | NOK | NOK | na |
| 2200 bags/h | | | | | | | |

All patents, test procedures, and other documents cited herein, including priority documents, are fully incorporated by reference to the extent such disclosure is not inconsistent with this invention and for all jurisdictions in which such incorporation is permitted.

The following non-limiting items are intended to be included within the scope of the present invention.

Item 1. A multi-layer film comprising:

(a) a first layer comprising at least about 80 wt % of a first mLLDPE having a density of from 0.910 g/cm³ to 0.930 g/cm³ based on the total weight of the first layer;

(b) a second layer comprising
(1) from about 60 wt % to about 90 wt % of a HDPE, having a density ranging from about 0.940 g/cm³ to about 0.965 g/cm³ and a melt index ranging from at least about 0.1 g/10 min to about 1.0 g/10 min,
(2) from about 40 wt % to about 10 wt % of a second mLLDPE, having a density ranging from about 0.910 g/cm³ to about 0.930 g/cm³ and a melt index ranging from about 0.2 g/10 min to about 3.5 g/10 min, and
(3) optionally, from about 0 wt % to about 10 wt % LDPE, wherein the wt % of the HDPE, the LDPE and the second mLLDPE is based on the total weight of the HDPE, the LDPE and the mLLDPE in the second layer; and

(c) optionally, a third layer comprising at least about 80 wt % of a third mLLDPE having a density of from 0.910 g/cm³ to 0.930 g/cm³ based on the total weight of the third layer,

wherein the first mLLDPE, the second mLLDPE and the third mLLDPE may be the same or different, and wherein the second layer is located between the first and the third layers.

Item 2. A multi-layer film according to Item 1, wherein the first layer is a skin layer.

Item 3. The multi-layer film according any of the preceding items, wherein the third layer is present and wherein each of the first and third layers independently further comprises about 0.5 to 10 wt %, preferably 3 to 5 wt % of a LDPE, wherein the wt % is based on the total weight of the first or third mLLDPE and LDPE, respectively.

Item 4. The multi-layer film according to any of the preceding items, wherein the second layer further includes a masterbatch containing additives.

Item 5. The multi-layer film according to item 4, wherein the additives are selected from the group consisting of: pigments and UV stabilizers.

Item 6. The multi-layer film according to any of the preceding items, wherein the first layer further includes a masterbatch containing additives.

Item 7. The multi-layer film according to any of the preceding items, wherein the third layer is present and wherein the third layer further includes a masterbatch containing additives.

Item 8. The multi-layer film according to either item 7 or 8, wherein the additives are selected from the group consisting of antiblock agents and processing aids.

Item 9. The multi-layer film according to any of the preceding items, wherein the second mLLDPE has a density ranging from about 0.912 g/cm³ to about 0.927 g/cm³.

Item 10. The multi-layer film according to any of the preceding items, wherein the second mLLDPE has a density ranging from about 0.915 g/cm³ to about 0.920 g/cm³.

Item 11. The multi-layer film according to any of the preceding items, wherein the MI of the second mLLDPE ranges from about 0.7 g/10 min to about 2.7 g/10 min.

Item 12. The multi-layer film according to any of the preceding items, wherein the MI of the second mLLDPE ranges from about 0.5 g/10 min to about 1.5 g/10 min.

Item 13. The multi-layer film according to any of the preceding items, wherein the third layer is present and wherein the first, second and third mLLDPEs are the same and wherein the mLLDPEs have a density ranging from about 0.915 to 0.920 g/cm³ and an MI ranging from about 0.5 to about 1.5 g/10 min.

Item 14. The multi-layer film according to any of the preceding items, wherein the second layer comprises from about 65 wt % to about 85 wt % of the HDPE and from about 35 wt % to about weight 15% of the second mLLDPE, wherein the wt % of the HDPE and the mLLDPE is based on the total weight of the HDPE and the second mLLDPE in the second layer.

Item 15. The multi-layer film according to any of items 1 to 13, wherein the second layer comprises from about 60 wt % to about 80 wt % of the HDPE and from about 40 wt % to about 20 wt % of the second mLLDPE, wherein the wt % of the HDPE and the mLLDPE is based on the total weight of the HDPE and the second mLLDPE in the second layer.

Item 16. The multi-layer film according to any of items 1 to 14, wherein the second layer comprises from about 70 to 85 wt %, preferably about 70 to 80 wt %, more preferably about 70 to 75 wt % of the HDPE and from about 30 to 15 wt %, preferably about 20 to 30 wt %, more preferably about 25 to 30 wt % of the second mLLDPE, wherein the wt % of the HDPE and the mLLDPE is based on the total weight of the HDPE and the second mLLDPE in the second layer.

Item 17. The multi-layer film according to any of the preceding items, wherein an MFR of the HDPE ranges from about 40 to about 150, preferably from about 60 to about 120, more preferably from about 90 to about 110.

Item 18. The multi-layer film according to any of the preceding items, wherein the MI of the HDPE ranges from about 0.10 g/10 min to about 0.40 g/10 min, preferably 0.10 g/10 min to about 0.30 g/10 min, more preferably 0.15 g/10 min to about 0.30 g/10 min.

Item 19. The multi-layer film according to any of the preceding items, wherein the density of the HDPE ranges from about 0.945 g/cm³ to about 0.960 g/cm³, preferably from 0.950 g/cm³ to about 0.960 g/cm³, preferably from 0.945 g/cm³ to about 0.955 g/cm³, more preferably from 0.950 g/cm³ to about 0.955 g/cm³.

Item 20. The multi-layer film according to any of the preceding items, wherein the multi-layer film has a seal time less than about 1 sec when contacted by a sealing bar at a temperature ranging from about 120° C. to about 220° C., preferably when contacted at a temperature ranging from about 130° C. to about 160° C.

Item 21. The multi-layer film according to any of the preceding items, wherein the seal time is less than or equal to about 0.7 sec, preferably less than or equal to about 0.5 sec, more preferably less than or equal to about 0.3 sec.

Item 22. The multi-layer film according to any of the preceding items, wherein the third layer is present and wherein the first layer, the second layer and the third layer have a relative thickness ratio ranging from about 1:1:1 to about 1:4:1.

Item 23. The multi-layer film according to item 22, wherein the third layer is present and wherein the first layer, the second layer and the third layer have a relative thickness ratio ranging from about 1:1:1 to about 1:2:1.

Item 24. The multi-layer film according to item 22, wherein the third layer is present and wherein the first layer, the second layer and the third layer have a relative thickness ratio ranging from about 1:2:1 to about 1:4:1.

Item 25. The multi-layer film according to any of the preceding items, wherein the multi-layer film has an increased value for at least one of MD tensile at yield, MD ultimate tensile at yield, TD 1% secant modulus, MD Elmendorf tear, TD Elmendorf tear, peak puncture force or dart drop relative to a standard resin high performance category film of the same thickness.

Item 26. The multi-layer film according to any of the preceding items, wherein the film has an increased value for at least one of TD 1% secant modulus or peak puncture force relative to a standard resin high performance category film of the same thickness.

Item 27. The multi-layer film according to any of the preceding items, wherein the multi-layer film has an increased value for each of MD tensile at yield, MD ultimate tensile at yield, TD 1% secant modulus, MD Elmendorf tear, TD Elmendorf tear, peak puncture force and dart drop relative to a standard resin high performance category film of the same thickness.

Item 28. The multi-layer film according to any of the preceding items, wherein the multi-layer film has a gauge ranging from about 50 microns to 150 microns, preferably from about 75 to about 125 microns, more preferably from about 90 to about 110 microns.

Item 29. The multi-layer film according to any of the preceding items, further comprising at least one interlayer between the first layer and the second layer.

Item 30. The multi-layer film according to any of the preceding items, wherein the third layer is present and further comprising at least one interlayer between the second layer and the third layer.

Item 31. A packaging material comprising the multi-layer film of any of the preceding items, wherein at least one of the first or third layers forms a seal during production of the packaging material.

Item 32. The packaging material of item 31, wherein the packaging material is a heavy duty sack

Item 33. A filled package comprising the packaging material of items 31 or 32, further comprising a filling material encapsulated within the package.

Item 34. The packaging material according to any of items 31 to 33 having a seal strength of at least about 0.3 N/μm film as measured on a 15 mm wide sample for a seal formed at a seal bar temperature of about 130° C. with a seal time of about 0.7 sec.

Item 35. The packaging material according to any of items 31 to 33 having a seal strength of at least about 0.3 N/μm film as measured on a 15 mm wide sample for a seal formed at a seal bar temperature of about 140° C. with a seal time of about 0.7 sec.

Item 36. The packaging material according to any of items 31 to 35 prepared on a VFFS (vertical form fill and seal) packaging line at rates of at least 2000 sacks per hour, preferably at lines rates of at least 2500 sacks per hour.

Item 37. The filled package according to any of items 33 to 36, wherein the filling material is selected from the group consisting of powdered materials and granular materials.

Item 38. A method of making a multi-layer film comprising coextruding:

(a) a first layer comprising at least about 80 wt % of a first mLLDPE having a density of from 0.910 g/cm³ to 0.930 g/cm³ based on the total weight of the first layer;

(b) a second layer comprising
(1) from about 60 wt % to about 90 wt % of a HDPE, having a density ranging from about 0.940 g/cm³ to about 0.965 g/cm³ and a melt index ranging from at least about 0.1 g/10 min to about 1.0 g/10 min,
(2) from about 40 wt % to about 10 wt % of a second mLLDPE, having a density ranging from about 0.910 g/cm³ to about 0.930 g/cm³ and a melt index ranging from about 0.2 g/10 min to about 3.5 g/110 min, and
(3) optionally, from about 0 wt % to about 10 wt % LDPE,

wherein the wt % of the HDPE, the LDPE and the second mLLDPE is based on the total weight of the HDPE, the LDPE and the mLLDPE in the second layer; and

(c) a third layer comprising at least about 80 wt % of a third mLLDPE having a density of from 0.910 g/cm³ to 0.930 g/cm³ based on the total weight of the third layer,

to form the multi-layer film in which the second layer is located between the first and third layers.

Item 39. The method according to item 38 further comprising blending the HDPE and the second mLLDPE to form a composition for extrusion as the second layer of the multi-layer film.

Item 40. The method according to items 38 or 39, further comprising selecting the first second and third mLLDPEs and HDPE in order to form a multi-layer film having an improved value for at least one of MD tensile at yield, MD ultimate tensile at yield, TD 1% secant modulus, MD Elmendorf tear, TD Elmendorf tear, peak puncture force or dart drop relative to a standard resin high performance category film of the same thickness.

Item 41. The method according to any of items 38 to 40, wherein the film has an improved value for each of MD tensile at yield, MD ultimate tensile at yield, TD 1% secant modulus, MD Elmendorf tear, TD Elmendorf tear, peak puncture force and dart drop relative to a standard resin high performance category film of the same thickness.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow. To the extent that our description is specific, this is solely for the purpose of illustrating preferred embodiments of our invention and should not be taken as limiting our invention to these specific embodiments. The use of subheadings in the description is intended to assist and is not intended to limit the scope of our invention in any way.

We claim:

1. A multi-layer film comprising:
(a) a first layer comprising at least about 80 wt % of a first mLLDPE having a density of from 0.910 g/cm³ to 0.930 g/cm³ based on the total weight of the first layer;
(b) a second layer comprising
(1) from about 60 wt % to about 90 wt % of a HDPE, having a density ranging from about 0.940 g/cm³ to about 0.965 g/cm³ and a melt index ranging from at least about 0.1 g/10 min to about 1.0 g/10 min,
(2) from about 40 wt % to about 10 wt % of a second mLLDPE, having a density ranging from about 0.910 g/cm³ to about 0.930 g/cm³ and a melt index ranging from about 0.2 g/10 min to about 3.5 g/10 min, and
(3) optionally, from about 0 wt % to about 10 wt % LDPE,
wherein the wt % of the HDPE, the LDPE and the second mLLDPE is based on the total weight of the HDPE, the LDPE and the mLLDPE in the second layer; and
(c) a third layer comprising at least about 80 wt % of a third mLLDPE having a density of from 0.910 g/cm³ to 0.930 g/cm³ based on the total weight of the third layer,
wherein the first mLLDPE, the second mLLDPE and the third mLLDPE may be the same or different, and wherein the second layer is located between the first and the third layers.

2. The multi-layer film according to claim 1, wherein each of the first and third layers independently further comprises about 0.5 to 10 wt % of a LDPE, wherein the wt % is based on the total weight of the first or third mLLDPE and LDPE, respectively.

3. The multi-layer film according to claim 2, wherein each of the first and third layers independently comprises from about 3 wt % to about 5 wt % of the LDPE.

4. The multi-layer film according to claim 1, wherein the second layer further includes a masterbatch containing additives.

5. The multi-layer film according to claim 4, wherein the additives are selected from the group consisting of: pigments and UV stabilizers.

6. The multi-layer film according to claim 1, wherein the first layer further includes a masterbatch containing additives.

7. The multi-layer film according to claim 1, wherein the third layer further includes a masterbatch containing additives.

8. The multi-layer film according to either claim 6 or claim 7, wherein the additives are selected from the group consisting of antiblock agents and processing aids.

9. The multi-layer film according to claim 1, wherein the second mLLDPE has a density ranging from about 0.912 g/cm³ to about 0.927 g/cm³.

10. The multi-layer film according to claim 1, wherein the MI of the second mLLDPE ranges from about 0.7 g/10 min to about 2.7 g/10 min.

11. The multi-layer film according to claim 1, wherein the first, second and third mLLDPEs are the same and wherein the mLLDPEs have a density ranging from about 0.915 to 0.920 g/cm³ and an MI ranging from about 0.5 to about 1.5 g/10 min.

12. The multi-layer film according to claim 1, wherein the second layer comprises from about 65 wt % to about 85 wt % of the HDPE and from about 35 wt % to about weight 15% of the second mLLDPE, wherein the wt % of the HDPE and the mLLDPE is based on the total weight of the HDPE and the second mLLDPE in the second layer.

13. The multi-layer film according to claim 1, wherein the second layer comprises from about 60 wt % to about 80 wt % of the HDPE and from about 40 wt % to about 20 wt % of the second mLLDPE, wherein the wt % of the HDPE and the mLLDPE is based on the total weight of the HDPE and the second mLLDPE in the second layer.

14. The multi-layer film according to claim 1, wherein the second layer comprises from about 70 wt % to about 85 wt % of the HDPE and from about 30 wt % to about 15 wt % of the second mLLDPE, wherein the wt % of the HDPE and the mLLDPE is based on the total weight of the HDPE and the second mLLDPE in the second layer.

15. The multi-layer film according to claim 14, wherein the second layer comprises from about 70 wt % to about 80 wt % of the HDPE and from about 30 wt % to about 20 wt % of the second mLLDPE, wherein the wt % of the HDPE and the mLLDPE is based on the total weight of the HDPE and the second mLLDPE in the second layer.

16. The multi-layer film according to claim 14, wherein the second layer comprises from about 70 wt % to about 75 wt % of the HDPE and from about 30 wt % to about 25 wt % of the second mLLDPE, wherein the wt % of the HDPE and the second mLLDPE is based on the total weight of the HDPE and the mLLDPE in the second layer.

17. The multi-layer film according to claim 1, wherein an MFR of the HDPE ranges from about 40 to about 150.

18. The multi-layer film according to claim 1, wherein the MFR of the HDPE ranges from about 60 to about 120.

19. The multi-layer film according to claim 1, wherein the MFR of the HDPE ranges from about 90 to about 110.

20. The multi-layer film according to claim 1, wherein the MI of the HDPE ranges from about 0.10 g/10 min to about 0.40 g/10 min.

21. The multi-layer film according to claim 20, wherein the MI of the HDPE ranging from about 0.10 g/10 min to about 0.30 g/10 min.

22. The multi-layer film according to claim 20, wherein the MI of the HDPE ranges from about 0.15 g/10 min to about 0.30 g/10 min.

23. The multi-layer film according to claim 1, wherein the density of the HDPE ranges from about 0.945 g/cm³ to about 0.960 g/cm³.

24. The multi-layer film according to claim 23, wherein the density of the HDPE ranges from about 0.950 g/cm³ to about 0.960 g/cm³.

25. The multi-layer film according to claim 24, wherein the density of the HDPE ranges from about 0.950 g/cm³ to about 0.955 g/cm³.

26. The multi-layer film according to claim 23, wherein the density of the HDPE ranges from about 0.945 g/cm³ to about 0.955 g/cm³.

27. The multi-layer film according to claim 1, wherein the multi-layer film has a seal time less than about 1 sec when contacted by a sealing bar at a temperature ranging from about 120° C. to about 220° C.

28. The multi-layer film according to claim 1, wherein the multi-layer film has a seal time less than about 1 sec when contacted by a sealing bar at a temperature ranging from about 130° C. to about 160° C.

29. The multi-layer film according to claim 27, wherein the seal time is less than or equal to about 0.7 sec.

30. The multi-layer film according to claim 29, wherein the seal time is less than or equal to about 0.5 sec.

31. The multi-layer film according to claim 29, wherein the seal time is less than or equal to about 0.3 sec.

32. The multi-layer film according to claim 1, wherein the first layer, the second layer and the third layer have a relative thickness ratio ranging from about 1:1:1 to about 1:4:1.

33. The multi-layer film according to claim 32, wherein the first layer, the second layer and the third layer have a relative thickness ratio ranging from about 1:1:1 to about 1:2:1.

34. The multi-layer film according to claim 32, wherein the first layer, the second layer and the third layer have a relative thickness ratio ranging from about 1:2:1 to about 1:4:1.

35. The multi-layer film according to claim 1, wherein the multi-layer film has an increased value for at least one of MD tensile at yield, MD ultimate tensile at yield, TD 1% secant modulus, MD Elmendorf tear, TD Elmendorf tear, peak puncture force or dart drop relative to a standard resin high performance category film of the same thickness.

36. The multi-layer film according to claim 35, wherein the film has an increased value for at least one of TD 1% secant modulus or peak puncture force relative to a standard resin high performance category film of the same thickness.

37. The multi-layer film according to claim 1, wherein the multi-layer film has an increased value for each of MD tensile at yield, MD ultimate tensile at yield, TD 1% secant modulus, MD Elmendorf tear, TD Elmendorf tear, peak puncture force and dart drop relative to a standard resin high performance category film of the same thickness.

38. The multi-layer film according to claim 1, wherein the multi-layer film has a gauge ranging from about 50 microns to 150 microns.

39. The multi-layer film according to claim 1, further comprising at least one interlayer between the first layer and the second layer.

40. The multi-layer film according to claim 1, further comprising at least one interlayer between the second layer and the third layer.

41. The multi-layer film according to claim 39, further comprising at least one interlayer between the second layer and the third layer.

42. A heavy duty sack comprising a multi-layer film comprising:
(a) a first layer comprising at least about 80 wt % of a first mLLDPE having a density of from 0.910 g/cm³ to 0.930 g/cm³ based on the total weight of the first layer;
(b) a second layer comprising
(1) from about 60 wt % to about 90 wt % of a HDPE, having a density ranging from about 0.940 g/cm³ to about 0.965 g/cm³ and a melt index ranging from at least about 0.1 g/10 min to about 1.0 g/10 min,
(2) from about 40 wt % to about 10 wt % of a second mLLDPE, having a density ranging from about 0.910 g/cm³ to about 0.930 g/cm³ and a melt index ranging from about 0.2 g/10 min to about 3.5 g/10 min, and
(3) optionally, from about 0 wt % to about 10 wt % LDPE,
wherein the wt % of the HDPE, the LDPE and the second mLLDPE is based on the total weight of the HDPE, the LDPE and the mLLDPE in the second layer; and
(c) a third layer comprising at least about 80 wt % of a third mLLDPE having a density of from 0.910 g/cm³ to 0.930 g/cm³ based on the total weight of the third layer,
wherein the first mLLDPE, the second mLLDPE and the third mLLDPE may be the same or different, wherein the second layer is located between the first and third layers, and wherein at least one of the first or third layers forms a seal during production of the heavy duty sack.

43. The heavy duty sack according to claim 42, wherein the multi-layer film has an improved value for at least one of MD tensile at yield, MD ultimate tensile at yield, TD 1% secant modulus, MD Elmendorf tear, TD Elmendorf tear, peak puncture force or dart drop relative to a Standard FFS resin bag high performance film having the same thickness.

44. The heavy duty sack according to claim 42, wherein the multi-layer film has an improved value for each of MD tensile at yield, MD ultimate tensile at yield, TD 1% secant modulus, MD Elmendorf tear, TD Elmendorf tear, peak puncture force and dart drop relative to a Standard FFS resin bag high performance film having the same thickness.

45. The heavy duty sack according to claim 42 having a seal strength of at least about 0.3 N/μm film as measured on a 15 mm wide sample for a seal formed at a seal bar temperature of about 130° C. with a seal time of about 0.7 sec.

46. The heavy duty according to claim 42 having a seal strength of at least about 0.3 N/μm film as measured on a 15 mm wide sample for a seal formed at a seal bar temperature of about 140° C. with a seal time of about 0.7 sec.

47. The heavy duty sack according to claim 42 prepared on a VFFS (vertical form fill and seal) packaging line at rates of at least 2000 sacks per hour.

48. The heavy duty sack according to claim 47 prepared on a VFFS packaging line at rates of about 2500 sacks per hour.

49. A method of making a multi-layer film comprising coextruding:
(a) a first layer comprising at least about 80 wt % of a first mLLDPE having a density of from 0.910 g/cm³ to 0.930 g/cm³ based on the total weight of the first layer;
(b) a second layer comprising
(1) from about 60 wt % to about 90 wt % of a HDPE, having a density ranging from about 0.940 g/cm³ to about 0.965 g/cm³ and a melt index ranging from at least about 0.1 g/10 min to about 1.0 g/10 min,
(2) from about 40 wt % to about 10 wt % of a second mLLDPE, having a density ranging from about 0.910 g/cm³ to about 0.930 g/cm³ and a melt index ranging from about 0.2 g/10 min to about 3.5 g/10 min, and
(3) optionally, from about 0 wt % to about 10 wt % LDPE, wherein the wt % of the HDPE, the LDPE and the second mLLDPE is based on the total weight of the HDPE, the LDPE and the mLLDPE in the second layer; and
(c) a third layer comprising at least about 80 wt % of a third mLLDPE having a density of from 0.910 g/cm³ to 0.930 g/cm³ based on the total weight of the third layer, to form the multi-layer film in which the second layer is located between the first and third layers.

50. The method according to claim 49 further comprising blending the HDPE and the second mLLDPE to form a composition for extrusion as the second layer of the multi-layer film.

51. The method according to claim 49, wherein the multi-layer film has an improved value for at least one of MD tensile at yield, MD ultimate tensile at yield, TD 1% secant modulus, MD Elmendorf tear, TD Elmendorf tear, peak puncture force or dart drop relative to a Standard FFS resin bag high performance film having the same thickness.

52. The method according to claim 49, wherein the film has an improved value for each of MD tensile at yield, MD ultimate tensile at yield, TD 1% secant modulus, MD Elmendorf tear, TD Elmendorf tear, peak puncture force and dart drop relative to a Standard FFS resin bag high performance film having the same thickness.

53. A multi-layer film comprising:
(a) a skin layer comprising at least about 80 wt % of a first mLLDPE having a density of from 0.910 g/cm³ to 0.930 g/cm³ based on the total weight of the skin layer; and
(b) a second layer comprising
(1) from about 60 wt % to about 90 wt % of a HDPE, having a density ranging from about 0.940 g/cm³ to about 0.965 g/cm³ and a melt index ranging from at least about 0.1 g/10 min to about 1.0 g/10 min,
(2) from about 40 wt % to about 10 wt % of a second mLLDPE, having a density ranging from about 0.910 g/cm³ to about 0.930 g/cm³ and a melt index ranging from about 0.2 g/10 min to about 3.5 g/10 min, and
(3) optionally, from about 0 wt % to about 10 wt % LDPE,
wherein the wt % of the HDPE, the LDPE and the second mLLDPE is based on the total weight of the HDPE, the LDPE and the mLLDPE in the second layer;
wherein the first mLLDPE and the second mLLDPE may be the same or different.

54. A packaging material comprising a multi-layer film comprising:
(a) a first layer comprising at least about 80 wt % of a first mLLDPE having a density of from 0.910 g/cm³ to 0.930 g/cm³ based on the total weight of the first layer;
(b) a second layer comprising
(1) from about 60 wt % to about 90 wt % of a HDPE, having a density ranging from about 0.940 g/cm³ to about 0.965 g/cm³ and a melt index ranging from at least about 0.1 g/10 min to about 1.0 g/10 min,
(2) from about 40 wt % to about 10 wt % of a second mLLDPE, having a density ranging from about 0.910 g/cm³ to about 0.930 g/cm³ and a melt index ranging from about 0.2 g/10 min to about 3.5 g/10 min, and
(3) optionally, from about 0 wt % to about 10 wt % LDPE, wherein the wt % of the HDPE, the LDPE and the second mLLDPE is based on the total weight of the HDPE, the LDPE and the mLLDPE in the second layer; and
(c) a third layer comprising at least about 80 wt % of a third mLLDPE having a density of from 0.910 g/cm³ to 0.930 g/cm³ based on the total weight of the third layer, wherein the first mLLDPE, the second mLLDPE and the third mLLDPE may be the same or different, wherein the second layer is located between the first and third layers, and wherein at least one of the first or third layers forms a seal during production of the packaging material.

55. A filled package comprising
(1) a multi-layer film comprising:
(a) a first layer comprising at least about 80 wt % of a first mLLDPE having a density of from 0.910 g/cm³ to 0.930 g/cm based on the total weight of the first layer;
(b) a second layer comprising
(i) from about 60 wt % to about 90 wt % of a HDPE, having a density ranging from about 0.940 g/cm³ to about 0.965 g/cm³ and a melt index ranging from at least about 0.1 g/10 min to about 1.0 g/10 min,
(ii) from about 40 wt % to about 10 wt % of a second mLLDPE, having a density ranging from about 0.910 g/cm³ to about 0.930 g/cm³ and a melt index ranging from about 0.2 g/10 min to about 3.5 g/10 min, and
(iii) optionally, from about 0 wt % to about 10 wt % LDPE, wherein the wt % of the HDPE, the LDPE and the second mLLDPE is based on the total weight of the HDPE, the LDPE and the mLLDPE in the second layer; and
(c) a third layer comprising at least about 80 wt % of a third mLLDPE having a density of from 0.910 g/cm³ to 0.930 g/cm³ based on the total weight of the third layer, wherein the first mLLDPE, the second mLLDPE and the third mLLDPE may be the same or different, wherein the second layer is located between the first and third layers, and wherein at least one of the first or third layers forms a seal during production of the package; and
(2) a filling material encapsulated within the package.

56. The filled package of claim 55, wherein the package is a heavy duty sack.

57. The filled package of claim 56, wherein the filling material is selected from the group consisting of powdered materials and granular materials.
